(19) United States
(12) Patent Application Publication
(10) Pub. No.: US 2022/0217949 A1
(43) Pub. Date: Jul. 14, 2022

(54) COLLARS WITH INTERCHANGEABLE PANELS

(71) Applicant: Diane Elizabeth Rose Bollinger, Ashburn, VA (US)

(72) Inventor: Diane Elizabeth Rose Bollinger, Ashburn, VA (US)

(21) Appl. No.: 17/647,411

(22) Filed: Jan. 7, 2022

Related U.S. Application Data
(60) Provisional application No. 63/199,556, filed on Jan. 8, 2021.

(51) Int. Cl. A01K 27/00

(52) U.S. Cl. CPC A01K 27/006; A01K 27/001

(57) ABSTRACT

An interchangeable collar system includes a base unit and a decorative panel removably fastened to an outward facing surface of the base unit with fasteners. The base unit also has an inward facing surface, a first tab that can connect to a second tab with a coupling component. A method of changing an appearance of a dog collar includes providing the collar base unit and a first decorative panel; removing the panel; and fastening a second decorative panel to the outward facing surface. The inventive system enables the user to switch between multiple designs without requiring the purchase of many collars.

### CROSS-REFERENCE TO RELATED APPLICATION

This application claims the benefit of priority of U.S. provisional application No. 63/199,556, filed Jan. 8, 2021, the contents of which are herein incorporated by reference.

### BACKGROUND OF THE INVENTION

The present invention relates to dog collars and, more particularly, to collars with interchangeable panels.

Fancy dog collars are expensive. Commercially available fancy collars are provided with only one design per collar. No other versions or combinations are available with a single collar. To achieve a different look, you must buy a new collar.

As can be seen, there is a need for a versatile dog collar system.

### SUMMARY OF THE INVENTION

The present invention provides a dog collar system with interchangeable panels. The inventive system enables the user to switch between multiple designs without requiring the purchase of many collars. The inventive interchangeable panel format is more flexible in appearance than a currently commercially available collar, allowing the user to mix and match styles. In the long run, the inventive collars are cheaper than currently commercially available collars in that 1 base with 5 panels generally costs less than 5 different collars.

In one aspect of the present invention, an interchangeable collar system is provided, comprising a base unit having an inward facing surface, an outward facing surface, a first tab, a second tab, and a coupling component operative to couple the first tab with the second tab; and a decorative panel removably fastened to the outward facing surface with fasteners.

In another aspect of the present invention, a method of changing an appearance of a dog collar is provided, comprising providing a collar base unit having an inward facing surface and an outward facing surface and a first decorative panel removably fastened to the outward facing surface; removing the first decorative panel from the outward facing surface; and fastening a second decorative panel to the outward facing surface.

These and other features, aspects and advantages of the present invention will become better understood with reference to the following drawings, description, and claims.

### BRIEF DESCRIPTION OF THE DRAWINGS

FIG. 1 is a perspective view of a dog collar according to an embodiment of the present invention, shown in a use position;

FIG. 2 is another perspective view thereof, shown in a flat position;

FIG. 3 is an exploded view thereof;

FIG. 4 is a sectional view thereof, taken along line 4-4 in FIG. 2;

FIG. 5 is another perspective view thereof, shown with an alternate panel;

FIG. 6 is a perspective view of a dog collar according to another embodiment according to the present invention, shown in use position; and

FIG. 7 is another perspective view thereof, shown in a flat position.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

As used herein, the term “collar” is not limited to an article worn about the neck. Rather, it refers to a band resembling a collar in shape and worn fastened around a part of an animal or human body.

Broadly, one embodiment of the present invention is an interchangeable collar system comprising at least one collar base unit and at least one removably attached decorative panel.

A single panel may be used with multiple base collar styles (such as a collar having a buckle, Martingale collar, French Martingale collar, etc.) or multiple panels may be used with a single base. The inventive collar combinations may be selected to celebrate holidays, show different color combinations, allow for different design styles, etc.

The size and use of the interchangeable collar system are not particularly limited. In some embodiments, the inventive collar may be a dog collar. In other embodiments, the inventive collar may be a bracelet or cuff. In yet other embodiments, the inventive collar may be a belt.

In some embodiments, the base and/or the panel are prepared from a precise template to ensure a superior fit. Additional templates with different spacing may be provided.

In some embodiments, a plurality of mating fasteners, such as Chicago screws, snaps, or hook and loop fasteners may removably hold the panel to the base. The user may remove a panel and replace or swap panels as desired.

The method of manufacture is not particularly limited. The components may be laser cut or cut by hand.

The materials of manufacture are not particularly limited. For example, the collar base, panel, and template may each be made from leather or another material, such as a coated polyester webbing marketed as BioThane®.

The collar system may be used by fastening a panel to a collar base and fastening the collar, for example, around a dog's neck. The user may change out the panel with another of the same size for different appearances. Additional types of collars may be made using a panel with different bases.

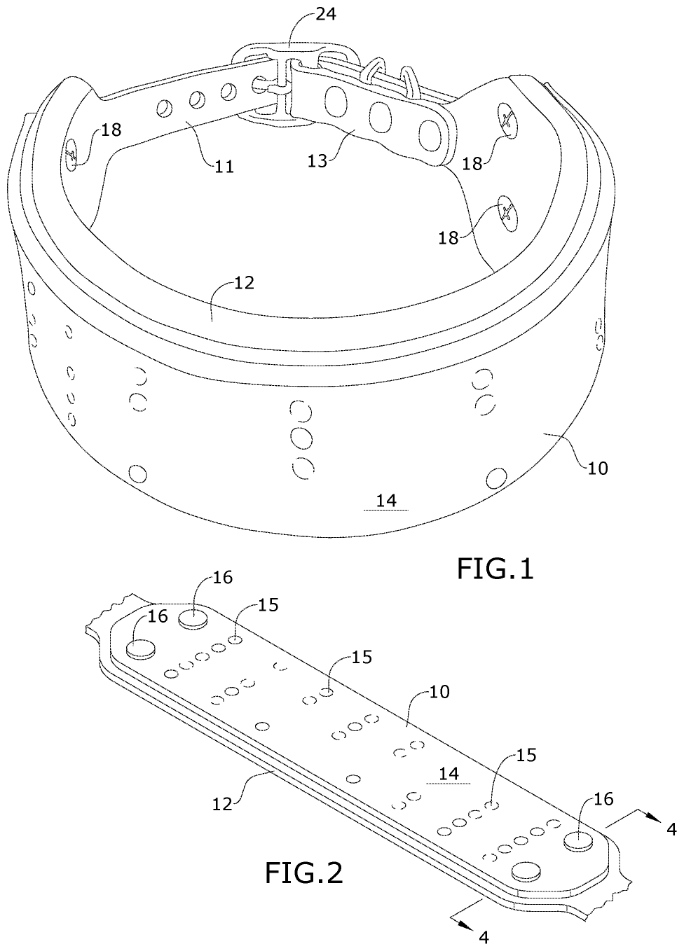

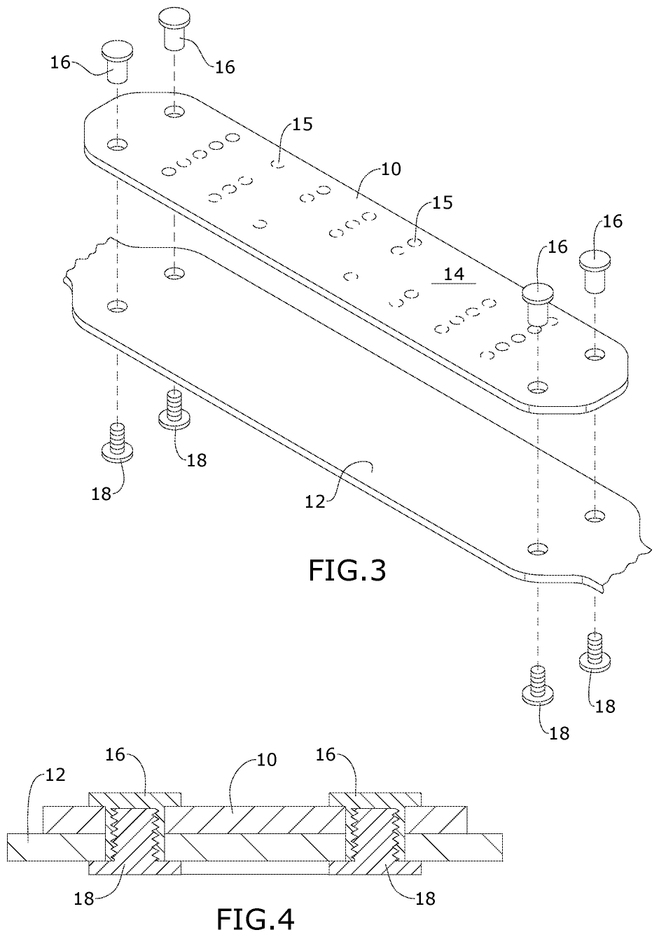

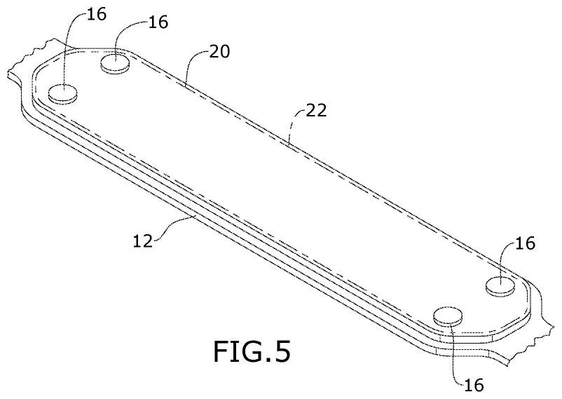

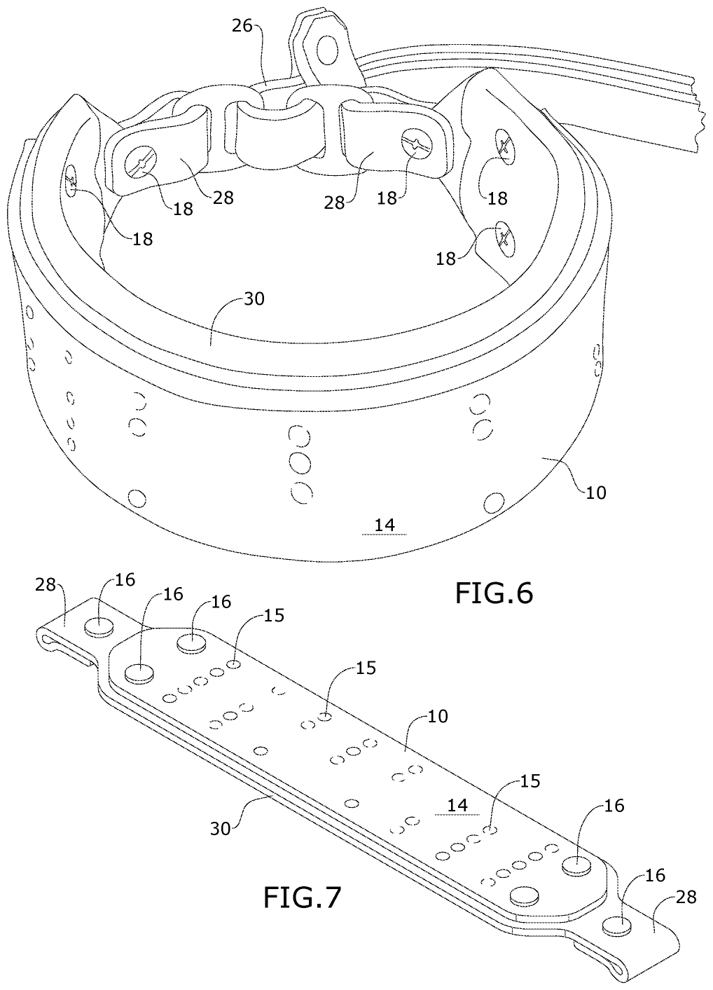

Referring to FIGS. 1 through 7, FIG. 1 illustrate a collar according to an embodiment of the present invention, having a panel 10 fastened to a base 12 with fasteners comprising a female component 16 and a male component 18, as shown in more detail in FIGS. 3 and 4. The base 12 has an elongated, substantially rectangular central portion with an inward facing surface, facing the wearer, and an outward facing surface visible to an observer during use, tapering to a first tab 11 at a first end and to a second tab 13 at a second end. A coupling component or buckle 24 detachably couples the first tab 11 to the second tab 13. In an open position, the buckle is operative to couple the first tab 11 with the second tab 13. As shown in FIG. 2, the panel 10 is substantially rectangular with angled corners and has a panel design area 14 displaying a decorative design 15. The panel 10 may have a somewhat smaller length and width than the central portion of the base 12. The panel 10 may be detached from the base 12 and replaced with an alternate panel 20 having an alternate panel design area 22, as shown in FIG. 5.

In another embodiment, a leash 26 may be attached to a base 30 by tabs 28 adjacent to the panel 10. The leash 26 may couple the tabs 28 together without a buckle.

It should be understood, of course, that the foregoing relates to exemplary embodiments of the invention and that modifications may be made without departing from the spirit and scope of the invention as set forth in the following claims.

What is claimed is:

1. An interchangeable collar system, comprising:
a base unit having an inward facing surface, an outward facing surface, a first tab, a second tab, and a coupling component operative to couple the first tab with the second tab; and
a decorative panel removably fastened to the outward facing surface with fasteners.

2. The interchangeable collar system of claim 1, further comprising a plurality of interchangeable decorative panels.

3. The interchangeable collar system of claim 1, wherein the base unit is selected from the group consisting of a collar having a buckle, a Martingale collar, and a French Martingale collar.

4. The interchangeable collar system of claim 1, wherein the base unit is a dog collar.

5. The interchangeable collar system of claim 1, wherein the base unit is a bracelet.

6. The interchangeable collar system of claim 1, further comprising a leash fastened to the base unit.

7. A method of changing an appearance of a dog collar, comprising:
providing a collar base unit having an inward facing surface and an outward facing surface and a first decorative panel removably fastened to the outward facing surface;
removing the first decorative panel from the outward facing surface; and
fastening a second decorative panel to the outward facing surface.

8. The method of claim 7, further comprising:
providing a second collar base unit having a second inward facing surface and a second outward facing surface; and
fastening the first decorative panel to the second outward facing surface.
